(19) United States
(12) Patent Application Publication
(10) Pub. No.: US 2025/0070125 A1
(43) Pub. Date: Feb. 27, 2025

(54) NEGATIVE ELECTRODE ACTIVE MATERIAL FOR ALL-SOLID-STATE BATTERY AND ALL-SOLID-STATE BATTERY INCLUDING THE SAME

(71) Applicant: ELECTRONICS AND TELECOMMUNICATIONS RESEARCH INSTITUTE, Daejeon (KR)

(72) Inventors: Ju Young KIM, Daejeon (KR); Young-Gi LEE, Daejeon (KR); Jaecheol CHOI, Daejeon (KR); Seok Hun KANG, Daejeon (KR)

(21) Appl. No.: 18/792,343

(22) Filed: Aug. 1, 2024

(30) Foreign Application Priority Data
Aug. 22, 2023 (KR) 10-2023-0109880
Jan. 11, 2024 (KR) 10-2024-0004932

(51) Int. Cl. H01M 4/36; H01M 4/02; H01M 4/133; H01M 4/134; H01M 4/38; H01M 4/583; H01M 10/0562

(52) U.S. Cl. CPC H01M 4/364; H01M 4/133; H01M 4/134; H01M 4/386; H01M 4/583; H01M 10/0562; H01M 2004/021; H01M 2004/027

(57) ABSTRACT

A negative electrode active material for an all-solid-state battery may include first graphite particles, second graphite particles, and silicon particles, wherein the first graphite particles have a spheroidal structure, the second graphite particles have a plate structure, the first graphite particles include about 30 to 80 parts by weight with respect to 100 parts by weight of the negative electrode active material, the second graphite particles include about 10 to 60 parts by weight with respect to 100 parts by weight of the negative electrode active material, and the silicon particles include about 5 to 15 parts by weight with respect to 100 parts by weight of the negative electrode active material.

### CROSS-REFERENCE TO RELATED APPLICATIONS

This U.S. non-provisional patent application claims priority under 35 U.S.C. § 119 of Korean Patent Application Nos. 10-2023-0109880, filed on Aug. 22, 2023, and 10-2024-0004932, filed on Jan. 11, 2024, the entire contents of which are hereby incorporated by reference.

### BACKGROUND

The present disclosure relates to a negative electrode for an all-solid-state battery and an all-solid-state battery including the same.

Recently, the development of batteries with high energy density and safety is being actively pursued as industrial demands. For example, lithium-ion batteries are being put to practical use not only in the fields of information-related devices and communication devices, but also in the automotive field. In the automotive field, safety is particularly important because it is related to life.

Recently, all-solid-state batteries that replace an electrolyte of lithium-ion batteries with solid electrolytes have been proposed. All-solid-state batteries may greatly reduce the possibility of fire or explosion even if a short circuit occurs because they do not use flammable organic solvents. Therefore, these all-solid-state batteries may have excellent safety.

### SUMMARY

The present disclosure provides a negative electrode active material with improved silicon dispersibility.

The present disclosure also provides an all-solid-state battery with improved stability and cell characteristics.

An embodiment of the inventive concept provides a negative electrode active material for an all-solid-state battery, the negative electrode active material including first graphite particles, second graphite particles, and silicon particles, wherein the first graphite particles have a spheroidal structure, the second graphite particles have a plate structure, the first graphite particles are about 30 to about 80 parts by weight with respect to 100 parts by weight of the negative electrode active material, the second graphite particles are about 10 to about 60 parts by weight with respect to 100 parts by weight of the negative electrode active material, and the silicon particles are about 5 to about 15 parts by weight with respect to 100 parts by weight of the negative electrode active material.

In an embodiment of the inventive concept, an all-solid-state battery includes: a positive electrode layer and a negative electrode layer separated from the positive electrode layer; and a solid electrolyte layer interposed between the positive electrode layer and the negative electrode layer, wherein the negative electrode layer includes a negative electrode current collector and a negative electrode active material layer on the negative electrode current collector, the negative electrode active material layer includes first graphite particles, second graphite particles, and silicon particles, the first graphite particles have a spheroidal shape, the second graphite particles have a sheet shape, the ratio of the second graphite particles to the first graphite particles is about 0.2 to about 2.5, and the silicon particles are about 5 to about 37.5 parts by weight with respect to 100 parts by weight of the second graphite particles.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a cross-sectional view of an all-solid-state battery according to an embodiment of the inventive concept;

FIG. 2 is an enlarged cross-sectional view of area M of FIG. 1;

FIGS. 3A, 3B, and 3C are scanning electron microscope (SEM) analysis results of negative electrodes for all-solid-state batteries according to embodiments of the inventive concept;

FIGS. 4A and 4B are scanning electron microscope (SEM) analysis results of negative electrodes for all-solid-state batteries according to comparative embodiments of the inventive concept;

FIG. 5 is a result of analyzing the ratio of graphite exposed on the surface according to the content of sheet graphite of the inventive concept;

FIGS. 6A and 6B are scanning electron microscope (SEM) analysis results of cross-sections of negative electrodes for all-solid-state batteries according to Comparative Example 1 and Example 4 of the inventive concept, respectively;

FIG. 7 is results of charge/discharge characteristics of all-solid-state batteries according to Examples 1 to 5 of and Comparative Example 1 of the inventive concept;

FIG. 8 is results of charge/discharge characteristics of all-solid-state batteries according to Example 4 and Comparative Example 2 of the inventive concept; and

FIG. 9 is results of charge/discharge characteristics of all-solid-state batteries according to Example 4, Comparative Example 3, and Comparative Example 4 of the inventive concept.

FIG. 10 is results of measuring ion diffusion of Examples 1 to 5, Comparative Example 1, and Comparative Example 2.

### DETAILED DESCRIPTION

In order to fully understand the configuration and effect of the present disclosure, preferred embodiments of the inventive concept are described with reference to the accompanying drawings. However, the present disclosure is not limited to the embodiments disclosed below, but may be implemented in various forms and may have various changes. The description of these embodiments is provided to merely ensure that the present disclosure is complete and to fully inform those who ordinary skilled in the technical field to which the present disclosure belongs of the scope of the inventive concept.

In this specification, when a component is referred to as being on another component, it means that the component may be disposed directly on the other component or an intervening component may be interposed therebetween. In addition, in the drawings, the thicknesses of components are exaggerated for effective explanation of the technical contents. Like reference numerals refer to like elements throughout the specification.

Embodiments described in this specification will be described with reference to cross-sectional views and/or plan views, which are ideal exemplifying views of the present disclosure. In the drawings, the thicknesses of the membranes and areas are exaggerated for effective explanation of the technical contents. Accordingly, areas illustrated in the drawings have a schematic nature, and the shapes of the areas illustrated in the drawings are intended to illustrate specific forms of areas of an element and are not intended to limit the scope of the inventive concept. Although the terms first, second, third, etc. have been used in various embodiments in this specification to describe various components, these components should not be limited by these terms. These terms are only used to distinguish one component from another. The embodiments described and illustrated herein also include their complementary embodiments.

The terminology used herein is intended to describe the embodiments and is not intended to limit the inventive concept. In this specification, the singular also includes the plural unless specifically stated otherwise in the phrase. The terms “comprises” and/or “comprising” used herein do not exclude the presence or addition of one or more other components.

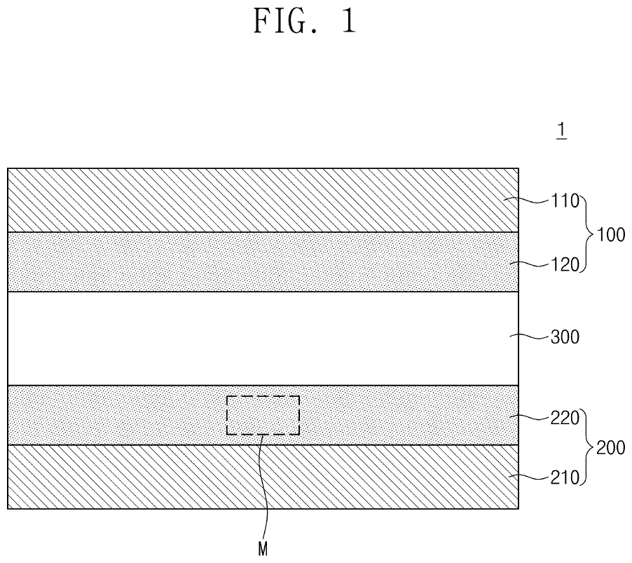

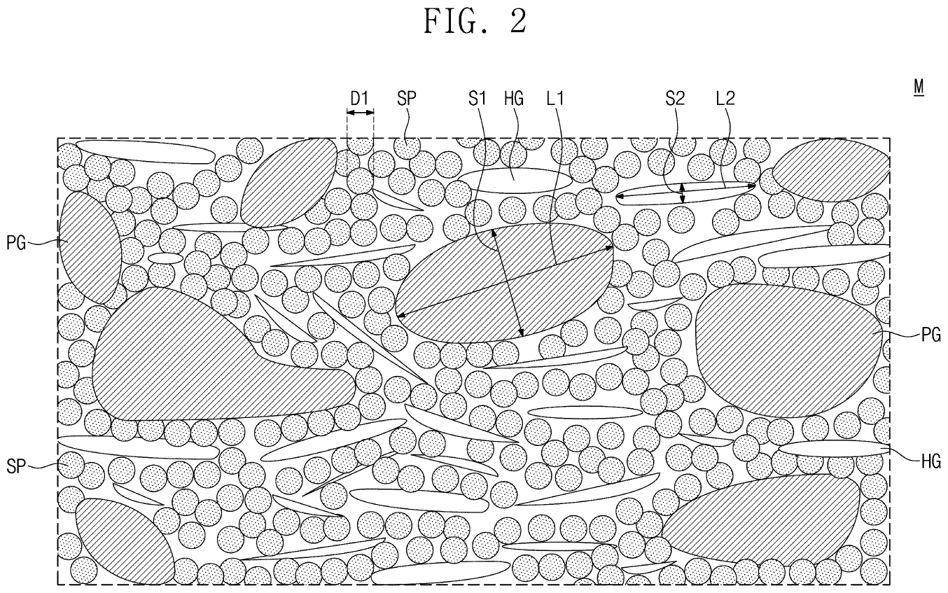

FIG. 1 is a cross-sectional view of an all-solid-state battery according to an embodiment of the inventive concept. FIG. 2 is an enlarged cross-sectional view of area M of FIG. 1.

Referring to FIG. 1, an all-solid-state battery 1 according to an example may include a positive electrode layer 100, a negative electrode layer 200 facing the positive electrode layer 100, and a solid electrolyte layer 300 disposed between the positive electrode layer 100 and the negative electrode layer 200. The positive electrode layer 100 and the negative electrode layer 200 may be spaced apart from each other with the solid electrolyte layer 300 therebetween.

The positive electrode layer 100 may include a positive electrode current collector 110 and a positive electrode active material layer 120 disposed on the positive electrode current collector 110. The positive electrode active material layer 120 may include a positive electrode active material, a solid electrolyte, a conductive material, and a binder.

The positive electrode current collector 110 may include a plate or foil including, for example, indium (In), copper (Cu), magnesium (Mg), stainless steel, titanium (Ti), iron (Fe), cobalt (Co), nickel (Ni), zinc (Zn), aluminum (Al), germanium (Ge), or an alloy thereof.

The positive electrode active material may include, but is not necessarily limited to, lithium transition metal oxides such as lithium cobalt oxide, lithium nickel oxide, lithium nickel cobalt oxide, lithium nickel cobalt aluminum oxide (NCA), lithium nickel cobalt manganese oxide (NCM), lithium manganate, and lithium iron phosphate, nickel sulfide, copper sulfide, lithium sulfide, iron oxide, or vanadium oxide. For example, the positive electrode active material may include at least one of LiNixCo—yMnzO2 (x+y+z=1), LiMn2O4, or LiFePO4.

The solid electrolyte of the positive electrode active material layer 120 may include the same material as the solid electrolyte layer 300 to be described below. For example, the solid electrolyte of the positive electrode active material layer 120 may include a sulfide-based solid electrolyte.

The positive electrode active material layer 120 may include a conductive material. The conductive material may have conductivity and increase the conductivity of the positive electrode active material. The conductive material may include a carbon-based material. The conductive material may include, for example, one or more selected from graphite, carbon black, acetylene black, carbon nanofibers, or carbon nanotubes.

The positive electrode active material layer 120 may further include a binder. The binder may bind the positive electrode active material, the solid electrolyte, the conductive material, and the like within the positive electrode active material layer 120 to each other. The binder may include a material for improving the bonding strength between the positive electrode active material layer 120 and the positive electrode current collector 110. The binder may include, for example, polyvinylidene fluoride, styrene-butadiene rubber (SBR), nitrile-butadiene rubber (NBR), polytetrafluoroethylene, polyvinylidene fluoride, vinylidene fluoride/hexafluoropropylene copolymer, polyacrylonitrile, and polymethyl methacrylate.

The solid electrolyte layer 300 may play a role in transferring ions between the positive electrode layer 100 and the negative electrode layer 200. The solid electrolyte layer 300 may include at least one of a sulfide-based solid electrolyte, an oxide-based solid electrolyte, a halogen-based solid electrolyte, or a polymer-based solid electrolyte.

The sulfide-based solid electrolyte may include at least one of Li4—xGe1—xPxS4(LGPS), Li3PS4-glass-ceramic, Li7P3S11 glass-ceramic (LPS), Li4SnS4, or Li6PS5X (X=I, Br, Cl). The oxide-based solid electrolyte may include at least one of Li1+xTi2−xMx(PO4)3 (M=Al, Ga, In, Sc), or Li7La3Zr2O12(LLZO).

The halogen-based solid electrolyte may include at least one of Li3ErX6, Li3GdX6, Li3YX6, Li3YX6, or Li3InC16 (X=I, Cl, Br). The polymer-based solid electrolyte may include a gel electrolyte or a polymer electrolyte, and may be in the form of a dissociated lithium salt existing within a polymer matrix. The polymer-based solid electrolyte may include at least one of polytetrafluoroethylene, polyvinylidene fluoride, poly(ethylene oxide), polyacrylonitrile, or hydroxypropyl cellulose. The lithium salt may include at least one of LiPF6, LiBF4, LiSbF6, LiAsF6, LiClO4, LiN(C2F5SO2)2, LiN(CF3SO2)2, CF3SO3Li, LiC(CF3SO2)3, or LiC4BO8.

When the solid electrolyte layer 200 includes the sulfide-based solid electrolyte or the oxide-based solid electrolyte, the solid electrolyte layer 200 may further include a polymer binder. The mechanical stability of the solid electrolyte layer 200 may be further improved by the polymer binder. For example, the polymer binder may include at least one of polytetrafluoroethylene, polyvinylidene fluoride, poly(ethylene oxide), polyacrylonitrile, hydroxypropyl cellulose, carboxymethyl cellulose, styrene-butadiene, or nitrile-butadiene rubber.

The negative electrode layer 200 may include a negative electrode current collector 210 and a negative electrode active material layer 220 disposed on the negative electrode current collector 210. The capacity ratio (n/p ratio) of the negative electrode layer 200 to the positive electrode layer 100 may be about 0.7 to about 2. The negative electrode current collector 210 may use a plate or foil including copper (Cu), stainless steel, titanium (Ti), nickel (Ni), aluminum (Al), or an alloy thereof. The negative electrode active material layer 220 may include a negative electrode active material and a polymer binder.

The negative electrode active material will be described in detail with reference to FIG. 2. FIG. 2 is a view illustrating the negative electrode active material of the negative electrode active material layer 220. Referring to FIG. 2, the negative electrode active material may include first graphite particles PG, second graphite particles HG, and silicon particles SP.

The first graphite particles PG may have a spheroidal structure. The first graphite particle PG may be spheroidal graphite. The first graphite particle PG may be graphite particles in which sheet-structured graphite particles are aggregated to form an oval or spherical shape. The first graphite particles PG may have a spherical structure in which a portion of the surface is sunken inward. The first graphite particles PG may have a spherical structure in which a portion of the surface protrudes outward. The cross-section of the first graphite particles PG may be circular or oval.

The first graphite particles PG may include a first short axis S1 and a first long axis L1. The ratio of the first long axis L1 to the first short axis S1 may be about 1 to about 4. The first short axis S1 may be defined as the minimum diameter of the first graphite particles PG, and the first long axis L1 may be defined as the maximum diameter of the first graphite particles PG. The first short axis S1 may be perpendicular to the first long axis L1.

The second graphite particles HG may have a plate structure. The second graphite particles HG may be sheet graphite. The second graphite particles HG may have a plate shape in a planar view. The cross-section of the second graphite particles HG may have a bar shape extending in a vertical direction or a horizontal direction. The cross-section of the second graphite particles HG may be elliptical.

The second graphite particles HG may include a second short axis S2 and a second long axis L2. The ratio of the second long axis L2 to the second short axis S2 may be about 4.1 to about 100. The second short axis S2 may be defined as the minimum diameter of the second graphite particles HG, and the second long axis L2 may be defined as the maximum diameter of the second graphite particles HG. The second short axis S2 may intersect the second long axis L2 perpendicularly. The first and second major axes L1, L2 may be about 1 μm to about 100 μm.

The second graphite particles HG may have a larger specific surface area than the first graphite particles PG. The specific surface area of the first graphite particles PG may be about 1 m²m²/g to about 3 m²/g. The specific surface area of the second graphite particles HG may be about 3.1 m²/g to about 30 m²/g.

The first graphite particles PG may be about 30 to about 80 parts by weight with respect to 100 parts by weight of the negative electrode active material. Preferably, the first graphite particle PG may be about 40 to about 70 parts by weight with respect to 100 parts by weight of the negative electrode active material. The second graphite particles HG may be about 10 to about 60 parts by weight with respect to 100 parts by weight of the negative electrode active material. Preferably, the second graphite particles HG may be about 20 to about 50 parts by weight with respect to 100 parts by weight of the negative electrode active material. The ratio of the second graphite particles HG to the first graphite particles PG may be about 0.2 to about 2.5.

The silicon particles SP may be interposed between the first graphite particles PG and the second graphite particles HG. The average diameter D1 of the silicon particles SP may be about 1 nm to about 500 nm. When the average diameter D1 of the silicon particles SP is greater than about 500 nm, the degree of dispersion of the silicon particles SP may decrease.

The silicon particles SP may be about 5 to about 15 parts by weight with respect to 100 parts by weight of the negative electrode active material. The silicon particles SP may be about 5 to about 37.5 parts by weight with respect to 100 parts by weight of the second graphite particles HG.

As another example, the negative electrode active material may include silicon oxide (SiOx, 0.5<x<1.5). The silicon oxide may have about 5 to about 15 parts by weight with respect to 100 parts by weight of the negative electrode active material.

The negative electrode active material layer 220 may further include a polymer binder. The polymer binder may include at least one of an aqueous or a non-aqueous material. For example, the polymer binder may include at least one of polytetrafluoroethylene, polyvinylidene fluoride (PVdF), poly(ethylene oxide), polyacrylonitrile, hydroxypropyl cellulose, carboxymethyl cellulose, styrene-butadiene, nitrile-butadiene rubber, polyacrylate and polyacrylic acid, polyvinyl alcohol, polyvinyl pyrrolidone, polyethyleneimine, xanthan gum, pectins, dextran, carrageenan, or guar gum. The polymer binder may be about 0.1 to about 5 parts by weight with respect to 100 parts by weight of the negative electrode active material layer 220.

The negative electrode active material layer 220 may include pores. The porosity of the negative electrode active material layer 220 may be about 1 vol % to about 20 vol %. Preferably, the porosity of the negative electrode active material layer 220 may be about 1 to about 15 vol %. The lower the porosity of the negative electrode active material layer 220 is, the more improved the ion diffusion between the negative electrode active material particles may be. Specifically, the porosity of the negative electrode active material 220 may be calculated as follows.

$$Porosity = 1 - ( \sum ayn / xn ) / b ( n = 1 , 2 , 3 … )$$

Regarding the porosity calculation formula above, a may be the weight of the negative electrode layer 200 per unit area, and b may be the height of the negative electrode layer 200. Each of xn and yn may be the density and composition ratio of the components of the negative electrode layer 200.

According to the present disclosure, the negative electrode active material may include first graphite particles having a spheroidal structure and second graphite particles having a plate structure. By including spheroidal graphite and sheet graphite, the degree of dispersion of silicon particles within an electrode may be improved, so that silicon particles may be evenly distributed within the negative electrode layer.

If the negative electrode active material includes only spheroidal graphite, silicon particles may not be evenly distributed throughout the electrode since the specific surface area of spheroidal graphite is relatively small. On the other hand, if the negative electrode active material includes only sheet graphite, the diffusion path of ions may be lengthened, so that the diffusion rate of ions may decrease. The negative electrode active material according to the present disclosure includes spheroidal graphite, sheet graphite, and silicon particles at an appropriate ratio, so that a high degree of dispersion of silicon particles and a diffusion path of ions may be secured.

In addition, the stress caused by the volume expansion of silicon particles during the lithiation reaction due to charging may be minimized. As a result, lithium ions may move stably, thereby improving the performance of an all-solid-state battery.

A method for producing a negative electrode active material layer according to the present disclosure will be described in detail.

The producing method according to the inventive concept may include: producing a negative electrode active material including first graphite particles, second graphite particles, and silicon particles; dissolving a polymer binder in a solvent; mixing the negative electrode active material and the polymer binder to produce a wet slurry; coating the wet slurry on a current collector; and drying the coated wet slurry to remove the solvent.

The producing of the wet slurry may include performing a wet process to produce an organic and/or aqueous slurry. The viscosity of the wet slurry may be from about 100 cP to about 10,000 cP. The viscosity of the wet slurry may be adjusted by dissolving a polymer binder in a solvent. The height of the wet slurry may vary depending on the areal capacity of a negative electrode. Specifically, the areal capacity of the negative electrode may be from about 1.6 mAh/cm² to about 6 mAh/cm².

The drying of the wet slurry may include hot air drying and vacuum drying in a reduced pressure atmosphere. Specifically, the drying may be performed at a temperature of ⅔ or higher of the boiling point of the solvent of the polymer binder for 30 minutes or longer to evaporate the solvent.

When producing a solid electrolyte layer 300 on a negative electrode layer 200, a uniaxial or triaxial pressurization process may be performed at a pressure of about 200 MPa or more to minimize the pores of the negative electrode layer 200.

Hereinafter, examples of the inventive concept will be described in more detail. However, these examples are intended to exemplify the inventive concept, and the scope of the inventive concept is not limited to these examples.

### Example 1

A negative electrode active material including spheroidal graphite, sheet graphite, and silicon particles in a weight ratio of about 80:10:10 was prepared. The specific surface area of spheroidal graphite measured using the Brunauer-Emmett-Teller (BET) analysis scheme was about 2.5533 m²/g, and the specific surface area of sheet graphite was about 14.6296 m²/g. The sheet graphite had a specific surface area about 5.73 times larger than that of spheroidal graphite.

A 10 wt % polyacrylic acid aqueous solution was prepared by dissolving polyacrylic acid in water. A wet process was performed to prepare an aqueous slurry in which the negative electrode active material and polyacrylic acid were mixed in a weight ratio of about 98:2. A slurry mixer was used to uniformly mix the negative electrode active material and polyacrylic acid.

The slurry was applied onto a nickel foil current collector to prepare a negative electrode layer. The theoretical capacity per unit area of the negative electrode layer was about 2 mAh/cm². Water was removed by hot air drying and vacuum drying at about 100° C.

A half-cell was prepared using the prepared negative electrode layer and a lithium metal layer as counter electrodes. Specifically, Li6PS5Cl particles were dispersed and pressurized to about 400 MPa to prepare a solid electrolyte membrane in the form of a pellet. One side of the solid electrolyte membrane was attached to the prepared negative electrode layer and pressurized to about 400 MPa to integrate the negative electrode layer and the solid electrolyte membrane. A lithium metal layer having a height of about 300 μm was attached to the other side of the solid electrolyte membrane to integrate the solid electrolyte membrane.

### Example 2

Example 2 is the same as Example 1 except that a negative electrode active material including spheroidal graphite, sheet graphite, and silicon particles in a weight ratio of about 70:20:10 was prepared.

### Example 3

Example 3 is the same as Example 1 except that a negative electrode active material including spheroidal graphite, sheet graphite, and silicon particles in a weight ratio of about 60:30:10 was prepared.

### Example 4

Example 4 is the same as Example 1 except that a negative electrode active material including spheroidal graphite, sheet graphite, and silicon particles in a weight ratio of about 50:40:10 was prepared.

### Example 5

Example 5 is the same as Example 1 except that a negative electrode active material including spheroidal graphite, sheet graphite, and silicon particles in a weight ratio of about 30:60:10 was prepared.

### Comparative Example 1

Comparative example 1 is the same as Example 1 except that a negative electrode active material including spheroidal graphite and silicon particles in a weight ratio of about 90:10 was prepared. Unlike Example 1, the negative electrode active material of Comparative Example 1 does not include sheet graphite.

### Comparative Example 2

Comparative Example 2 is the same as Example 1 except that a negative electrode active material including sheet graphite and silicon particles in a weight ratio of about 90:10 was prepared. Unlike example 1, the negative electrode active material of comparative example 1 does not include spheroidal graphite.

### Comparative Example 3

Comparative Example 3 is the same as Example 1 except that a negative electrode active material including spheroidal graphite, sheet graphite, and silicon particles in a weight ratio of about 50:40:20 was prepared.

### Comparative Example 4

Comparative Example 4 is the same as Example 1 except that a negative electrode active material including spheroidal graphite, sheet graphite, and silicon particles in a weight ratio of about 50:40:30 was prepared.

Table 1 below shows results of comparing the weight ratios of spheroidal graphite, sheet graphite, and silicon particles in examples and comparative examples.

TABLE 1

| | | Spheroidal | Sheet | Silicon |
|---|---|---|---|---|
| | | graphite | graphite | particles |
| Example | 1 | 80 | 10 | 10 |
| | 2 | 70 | 20 | 10 |
| | 3 | 60 | 30 | 10 |
| | 4 | 50 | 40 | 10 |
| | 5 | 30 | 60 | 10 |
| Comparative | 1 | 90 | — | 10 |
| Example | 2 | — | 90 | 10 |
| | 3 | 45.4 | 36.4 | 18.2 |
| | 4 | 41.7 | 33.3 | 25 |

### [Experimental Example 1]: Surface SEM Analysis

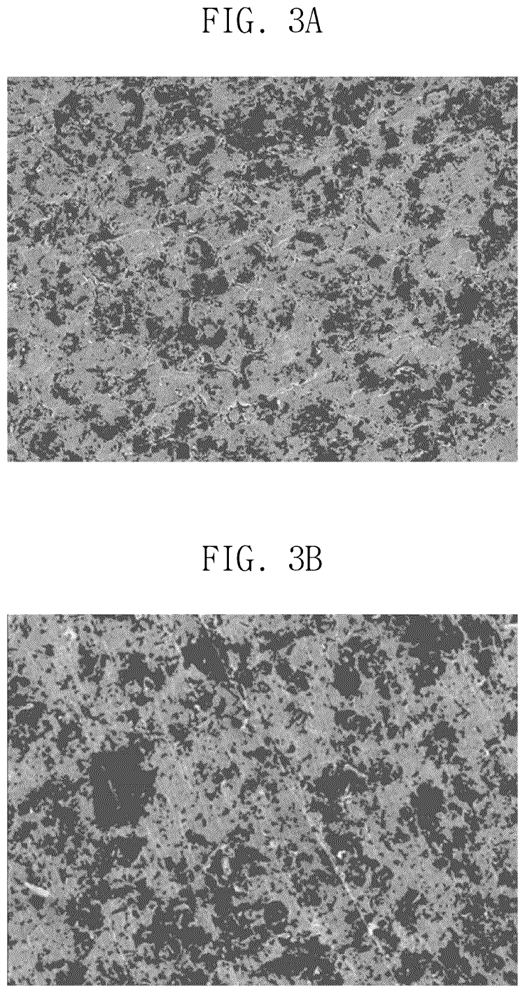

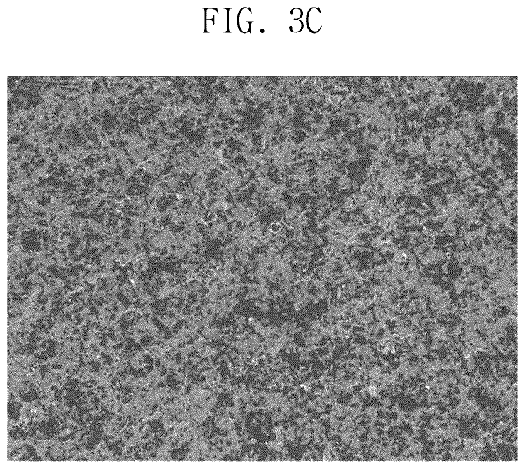

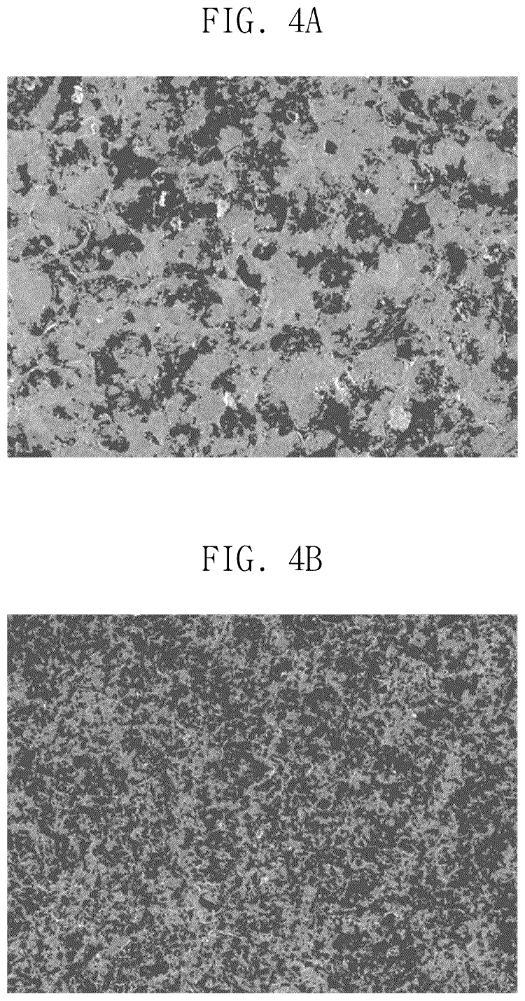

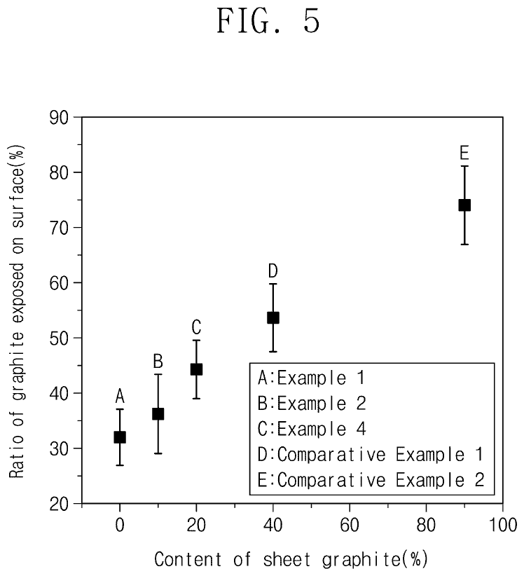

FIGS. 3A, 3B, and 3C are scanning electron microscope (SEM) analysis results of negative electrodes for all-solid-state batteries according to Examples 1, 2, and 4. FIGS. 4A and 4B are scanning electron microscope (SEM) analysis results of negative electrodes for all-solid-state batteries according to Comparative Examples 1 and 2. FIG. 5 is a result of analyzing the ratio of graphite exposed on the surface according to Examples 1, 2, and 4 and Comparative Examples 1 and 2.

In the SEM analysis, graphite with high conductivity was observed as black, silicon particles with low conductivity were observed as white, and based thereon, graphite exposed on the surface was indicated in red. Referring to FIGS. 3A to 4B, it was confirmed that as the amount of sheet graphite increased, silicon was distributed more evenly within the active material.

Referring to FIG. 5, it was confirmed that as the content of sheet graphite increased, the ratio of the area of graphite exposed on the surface of the negative electrode increased linearly. Accordingly, it was confirmed that the area ratio of silicon particles decreased.

Through this, it was confirmed that as the ratio of sheet graphite with a relatively large specific surface area increased, a space enabling distribution of silicon particles increased, and the silicon particles were uniformly distributed.

### [Experimental Example 2]: Cross-Sectional SEM Analysis

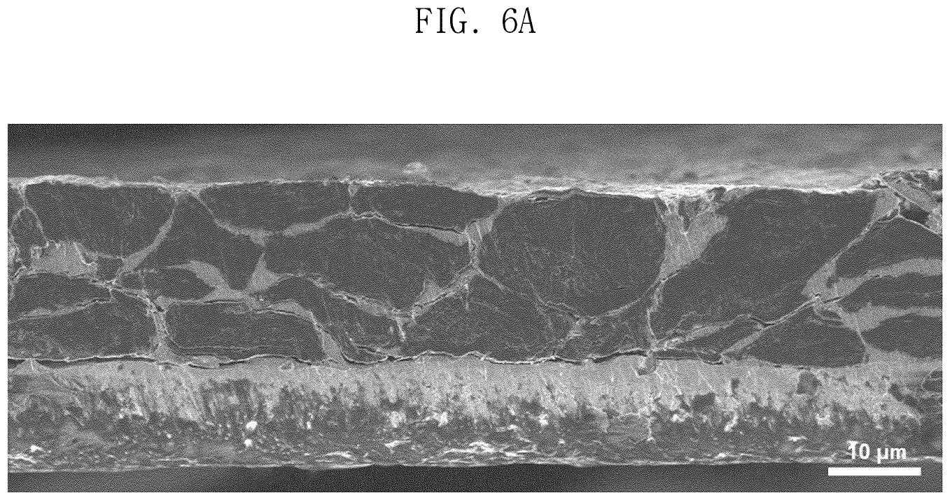

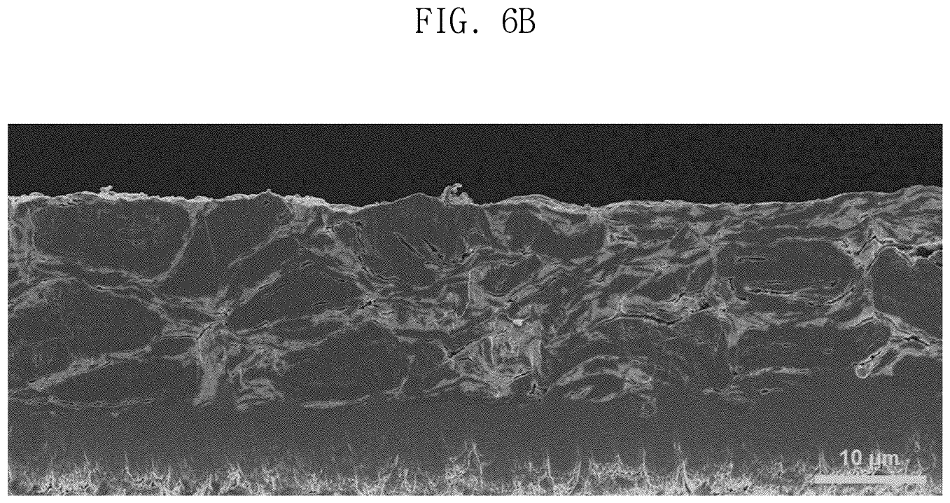

FIGS. 6A and 6B are scanning electron microscope (SEM) analysis results of cross-sections of negative electrodes for all-solid-state batteries according to comparative examples 1 and 4 of the inventive concept, respectively.

Referring to FIG. 6A, it was confirmed that silicon particles were distributed locally when only spheroidal graphite was included. On the other hand, referring to FIG. 6B, it was confirmed that silicon particles were evenly distributed throughout a negative electrode layer when spheroidal graphite and sheet graphite were included.

Through the experimental results, it was confirmed that silicon particles were evenly distributed when sheet graphite with a relatively large specific surface area was included.

### [Experimental Example 3]: Charge and Discharge Evaluation

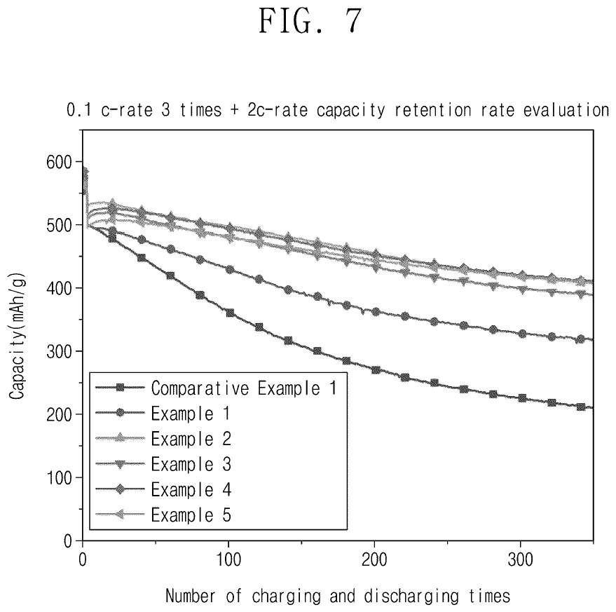

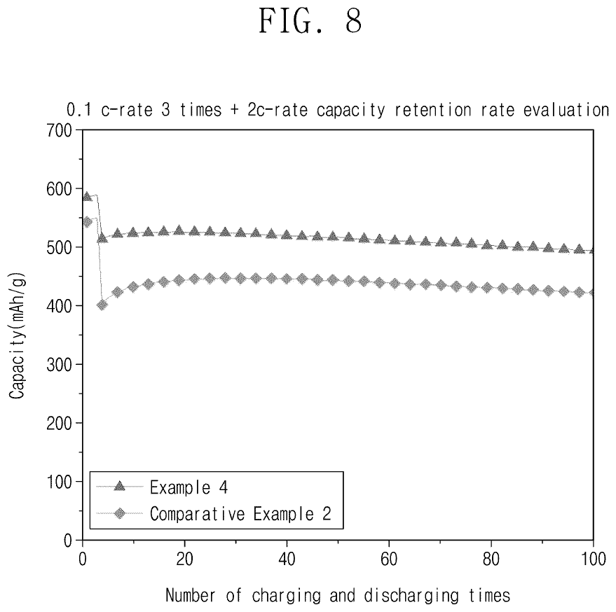

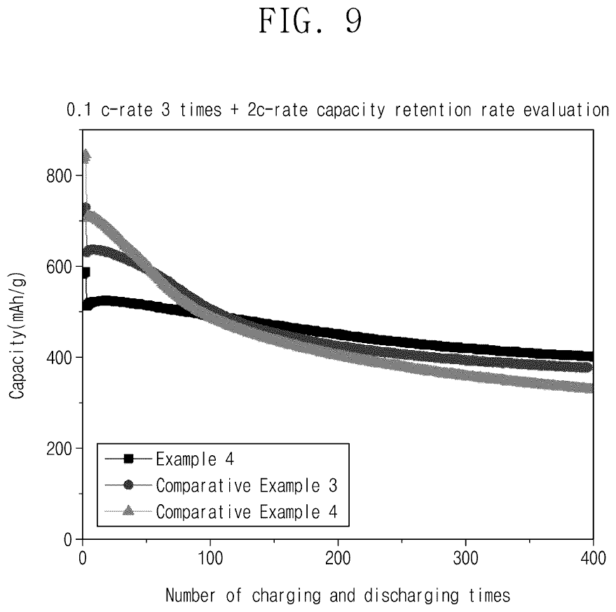

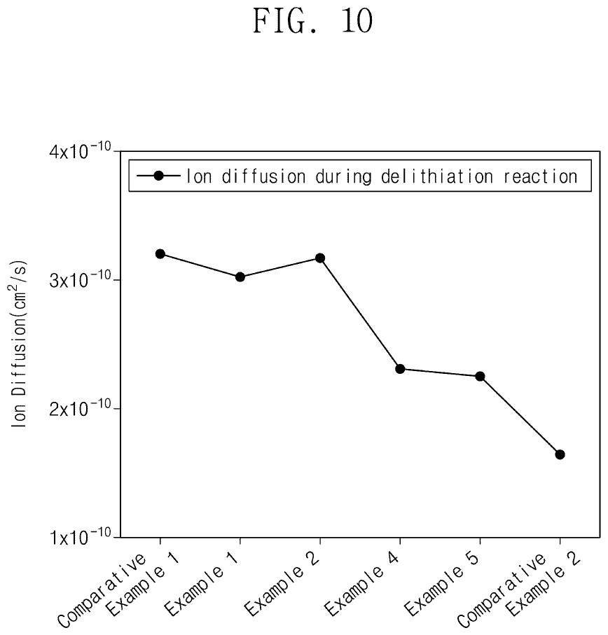

FIG. 7 is results of charge/discharge characteristics of all-solid-state batteries according to Examples 1 to 5 of and Comparative Example 1 of the inventive concept. FIG. 8 is results of charge/discharge characteristics of all-solid-state batteries according to Example 4 and Comparative Example 2 of the inventive concept. FIG. 9 is results of charge/discharge characteristics of all-solid-state batteries according to Example 4, Comparative Example 3, and Comparative Example 4 of the inventive concept.

Charge and discharge evaluations of electrodes according to Examples 1 to 5 and Comparative Examples 1 and 2 were performed. Charge and discharge evaluations were performed at about 60° C. The voltage cut-off condition was about 0.01 V to about 2.0 V. Charge was a delithiation reaction of a negative electrode layer, and discharge was a lithiation reaction of the negative electrode layer.

The discharge condition was constant current (CC)/constant voltage (CV). A CV process was terminated when a current value became ⅕ of the current value of a CC section. The charge condition was performed up to about 2 V under constant current (CC) conditions. The theoretical capacity of graphite was about 372 mAh/g, and the theoretical capacity of silicon was about 3579 mAh/g.

The capacity retention rate was evaluated by performing charging and discharging three times at a current (0.1 C-rate) that reaches the theoretical capacity after 10 hours of charge and discharge based on the theoretical capacity, and by performing charging and discharging at a current (2 C-rate) that reaches the theoretical capacity after about 0.5 hours of charge and discharge based on the theoretical capacity.

### (1) Comparison of Charge/Discharge Characteristics of Examples 1 to 5 and Comparative Example 1

Referring to FIG. 7, the average capacities of Examples 1 to 4 at about 0.1 C-rate were about 556 mAh/g, about 583 mAh/g, about 571 mAh/g, about 585 mAh/g, and about 554 mAh/g, respectively. The average capacity of comparative Example 1 at about 0.1 C-rate was about 575 mAh/g, which was similar to the examples. The average capacities of Examples 1 to 4 at about 2 C-rate were about 495 mAh/g, about 531 mAh/g, about 518 mAh/g, and about 498 mAh/g, respectively. The average capacity of Comparative Example 1 at about 2 C-rate was about 496 mAh/g, which was similar to the examples.

However, in the case of Comparative Example 1, the capacity occurred rapidly during 2 C-rate charge/discharge, and the capacity retention rate was about 42.1% after 350 charge/discharge cycles. On the other hand, Examples 2 to 5 showed high capacity retention rates of about 76.9%, about 76.6%, about 79.8%, and about 82.4%, respectively. In the case of Example 1, the capacity retention rate was about 63.9% since sufficient sheet graphite is not included.

### (2) Comparison of Charge and Discharge Characteristics of Example 4 and Comparative Example 2

Referring to FIG. 8, the average capacity values at about 0.1 C-rate and about 2 C-rate of comparative Example 2 were about 545 mAh/g and about 415 mAh/gd, respectively, which were lower than those of Example 4. Therefore, it is possible to see that spheroidal graphite contributes to an ion transfer path within an electrode. Specifically, when only sheet graphite is included, lithium ions do not move linearly but take a detour, which may lower ion diffusion within the electrode and lower the capacity realization rate of the electrode. Therefore, it can be seen that an appropriate mixture of spheroidal graphite and sheet graphite is necessary.

### (3) Comparison of Charge and Discharge Characteristics of Example 4 and Comparative Examples 3 and 4

Referring to FIG. 9, the average capacity values of Comparative Examples 3 and 4 were about 723 mAh/g and about 836 mAh/g at about 0.1 C-rate, and about 634 mAh/g and about 705 mAh/g at about 2 C-rate, respectively, which were higher than the average capacity value of example 4.

However, in Comparative Examples 3 and 4, the internal stress that occurred according to an increase in the content of silicon particles increased. Accordingly, the interfacial stability between particles in an electrode decreased, and the capacity decreased rapidly as charge and discharge progressed. As a result, Comparative Examples 3 and 4 showed lower capacities than Example 4 after 100 charge and discharge cycles.

A rapid change in capacity in a negative electrode layer may cause a rapid decrease in the available capacity of a full cell. Accordingly, it is important to show stable charge and discharge capacities during charge and discharge, as in Example 4. Through this, it is possible to see that the capacity retention rate decreases when the content of silicon particles is too high even when spheroidal graphite and sheet graphite are included.

Through the experimental results, it was confirmed that the capacity retention rate during charge and discharge of a battery including spheroidal graphite, sheet graphite, and silicon particles in an appropriate ratio was excellent.

### [Experimental Example 4]: Evaluation of Ion Diffusion Within Electrode

FIG. 10 shows a result of measuring ion diffusion of each of Examples 1 to 5, Comparative Example 1, and Comparative Example 2.

The ion diffusion within an electrode was measured using the galvanostatic intermittent titration technique (GITT). Specifically, after performing charge/discharge at about 0.3 C-rate for about 10 minutes, the electrode was rested for about 5 hours to analyze the diffusion behavior within the electrode. FIG. 10 shows an analysis result based on the Fick's law.

Referring to FIG. 10, the ion diffusion within the electrode decreased as the content of sheet graphite increased. In addition, Comparative Example 2, which consists only of sheet graphite and silicon particles, showed the lowest ion diffusion.

Through the result, it can be seen that the performance difference between Example 4 and Comparative Example 2 is due to the difference in the degree of silicon particle dispersion. In addition, it can be seen that the capacity retention results of Examples 1 to 5 (see FIG. 7) are not directly related to ion diffusion, and ultimately the capacity retention is more closely related to the degree of dispersion of silicon particles.

According to embodiments of the inventive concept, a negative electrode active material may include first graphite particles, second graphite particles, and silicon particles. The first graphite particles have a spheroidal structure, and the second graphite particles have a plate structure. By including the first graphite particles having a spheroidal structure and the second graphite particles having a plate structure, the silicon particles may be evenly distributed within a negative electrode. In addition, the volume expansion of silicon due to charging may be minimized, thereby reducing stress occurring within an electrode. As a result, a negative electrode active material of the present disclosure and an all-solid-state battery including the same may have improved cell characteristics.

Although examples of the present disclosure have been described with reference to the accompanying drawings, the present disclosure may be implemented in other specific forms without changing the technical idea or essential features thereof. Therefore, it should be understood that examples described above are exemplary in all respects and not restrictive.

What is claimed is:

1. A negative electrode active material for an all-solid-state battery, the negative electrode active material comprising:
first graphite particles;
second graphite particles, and
silicon particles,
wherein the first graphite particles have a spheroidal structure, the second graphite particles have a plate structure,
the first graphite particles are about 30 to about 80 parts by weight with respect to 100 parts by weight of the negative electrode active material,
the second graphite particles are about 10 to about 60 parts by weight with respect to 100 parts by weight of the negative electrode active material,
and the silicon particles are about 5 to about 15 parts by weight with respect to 100 parts by weight of the negative electrode active material.

2. The negative electrode active material of claim 1, wherein the silicon particles are about 5 to about 37.5 parts by weight with respect to 100 parts by weight of the second graphite particles.

3. The negative electrode active material of claim 1, wherein the ratio of the second graphite particles with respect to the first graphite particles is about 0.2 to about 2.5.

4. The negative electrode active material of claim 1, wherein the first graphite particles have a first short axis and a first long axis, and the ratio of the first long axis to the first short axis is about 1 to about 4.

5. The negative electrode active material of claim 1, wherein the second graphite particles have a second short axis and a second long axis, and the ratio of the second long axis to the second short axis is about 4.1 to about 100.

6. The negative electrode active material of claim 1, wherein a specific surface area of the first graphite particles is about 1 m²/g to about 3 m²/g.

7. The negative electrode active material of claim 1, wherein a specific surface area of the second graphite particles is about 3.1 m²/g to about 30 m²/g.

8. The negative electrode active material of claim 1, wherein an average diameter of the silicon particles is about 1 nm to about 500 nm.

9. A negative electrode for an all-solid-state battery, the negative electrode comprising:
a current collector; and
an active material layer on the current collector,
wherein the active material layer comprises the negative electrode active material of claim 1.

10. The negative electrode for an all-solid-state battery of claim 9, wherein the active material layer further comprises a binder, and the binder is about 0.1 to about 5 parts by weight with respect to 100 parts by weight of the active material layer.

11. The negative electrode for an all-solid-state battery of claim 9, wherein porosity of the active material layer is about 1 vol % to about 20 vol %.

12. An all-solid-state battery comprising:
a positive electrode layer and a negative electrode layer separated from the positive electrode layer; and
a solid electrolyte layer interposed between the positive electrode layer and the negative electrode layer,
wherein the negative electrode layer comprises a negative electrode current collector and a negative electrode active material layer on the negative electrode current collector,
the negative electrode active material layer comprises first graphite particles, second graphite particles, and silicon particles,
the first graphite particles have a spheroidal shape, the second graphite particles have a sheet shape,
the ratio of the second graphite particles to the first graphite particles is about 0.2 to about 2.5, and
the silicon particles are about 5 to about 37.5 parts by weight with respect to 100 parts by weight of the second graphite particles.

13. The all-solid-state battery of claim 12, wherein the first graphite particles have a first short axis and a first long axis, and the ratio of the first long axis to the first short axis is about 1 to 4.

14. The all-solid-state battery of claim 12, wherein the second graphite particles have a second short axis and a second long axis, and the ratio of the second long axis to the second short axis is about 4.1 to 100.

15. The all-solid-state battery of claim 12, wherein porosity of the negative electrode active material layer is about 1 vol % to about 20 vol %.
